(19) United States
(12) Patent Application Publication
(10) Pub. No.: US 2017/0063097 A1
(43) Pub. Date: Mar. 2, 2017

(54) HYSTERESIS COMPARATOR CIRCUIT AND POWER SUPPLY APPARATUS

(71) Applicant: FUJITSU LIMITED, Kawasaki-shi (JP)

(72) Inventors: HONG GAO, Inagi (JP); Hiroyuki Nakamoto, Kawasaki (JP)

(73) Assignee: FUJITSU LIMITED, Kawasaki-shi (JP)

(21) Appl. No.: 15/252,668

(22) Filed: Aug. 31, 2016

(30) Foreign Application Priority Data
Sep. 1, 2015 (JP) 2015-171791

(51) Int. Cl. H02J 4/00

(52) U.S. Cl. CPC H02J 4/00

(57) ABSTRACT

A hysteresis comparator circuit includes: a first switch that is coupled between a power supply line and an output terminal, is turned off when a supplied voltage on the power supply line is below a first value and is turned on when the supplied voltage is equal to or above the first value; a second switch coupled between the output terminal and a reference power line at a reference potential; and a control circuit that includes a third switch coupled between the power supply line and the reference power line. The third switch is turned off when the supplied voltage is below a second value that is smaller than the first value, and is turned on when the supplied voltage is equal to or above the second value. The control circuit turns the second switch on when the third switch is off, and turns the second switch off when the third switch is on.

### CROSS-REFERENCE TO RELATED APPLICATION

This application is based upon and claims the benefit of priority of the prior Japanese Patent Application No. 2015-171791, filed on Sep. 1, 2015, the entire contents of which are incorporated herein by reference.

### FIELD

The present embodiments discussed herein are related to a hysteresis comparator circuit and a power supply apparatus.

### BACKGROUND

To monitor a power supply voltage, a comparator circuit that compares the power supply voltage with a threshold voltage and outputs a comparison result is used.

There are also comparator circuits that output a comparison result produced by comparing the power supply voltage with a first threshold when the power supply voltage is rising and comparing the power supply voltage with a second threshold of a different magnitude to the first threshold when the power supply voltage is falling. This type of comparator circuit with a hysteresis characteristic (hereinafter referred to simply as a “hysteresis comparator circuit”) is capable of reducing chattering when there are frequent transitions in the comparison result due to power supply noise.

In recent years, there has been increasing attention on “energy harvesting” where unused energy, such as light energy, thermal energy, and vibration energy, present around us in the environment is converted (or “harvested”) into electrical power.

See, for example, the following documents:

Japanese Examined Patent Application Publication No. 07-66014;

Japanese Laid-open Patent Publication No. 2003-110414; and

Japanese Examined Patent Application Publication No. 63-59282.

When, as with energy harvesting, small amounts of power are used as a power supply, the power supply voltage tends to be comparatively unstable, resulting in the risk of chattering at a comparator that compares the power supply voltage with a single threshold voltage. For this reason, it is conceivable to use a hysteresis comparator circuit like that described above.

However, a conventional hysteresis comparator circuit sets the thresholds by feeding back the output voltage (i.e., the comparison result) to the input side, so that there are comparatively many paths on which a current continuously flows between the power supply line to which the power supply voltage is applied and a reference power supply line, resulting in the problem of high power consumption.

### SUMMARY

In one aspect of the embodiments, there is provided a hysteresis comparator circuit including: a first switch coupled between a power supply line and an output terminal, the first switch being configured to be turned off when a power supply voltage applied to the power supply line is smaller than a first value and be turned on when the power supply voltage is equal to or larger than the first value; a second switch coupled between the output terminal and a reference power supply line that is at a reference potential; and a control circuit that includes a third switch coupled between the power supply line and the reference power supply line, the third switch being configured to be turned off when the power supply voltage is smaller than a second value that is smaller than the first value, and be turned on when the power supply voltage is equal to or larger than the second value, wherein the control circuit is configured to turn the second switch on when the third switch is off, and turn the second switch off when the third switch is on.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts one example of a hysteresis comparator circuit according to a first embodiment;

FIG. 2 depicts examples of output values based on comparison results for a single threshold and a power supply voltage;

FIG. 3 depicts an example of the relationship between the power supply voltage and the output value of the hysteresis comparator circuit according to the present embodiment;

FIG. 4 depicts one example of a hysteresis comparator circuit that sets a threshold by feeding back an output value to the input side;

FIG. 5 depicts an example of a hysteresis comparator circuit according to a second embodiment;

FIG. 6 depicts one example of operation simulation results for the hysteresis comparator circuit according to the second embodiment;

FIG. 7 depicts an example of a hysteresis comparator circuit according to a third embodiment;

FIG. 8 depicts an example of a hysteresis comparator circuit according to a fourth embodiment; and

FIG. 9 depicts one example of a power supply apparatus and a semiconductor apparatus including such power supply apparatus.

### DESCRIPTION OF EMBODIMENTS

Several embodiments will be described below with reference to the accompanying drawings, wherein like reference numerals refer to like elements throughout. Note that the following embodiments can be implemented in combination as appropriate.

### First Embodiment

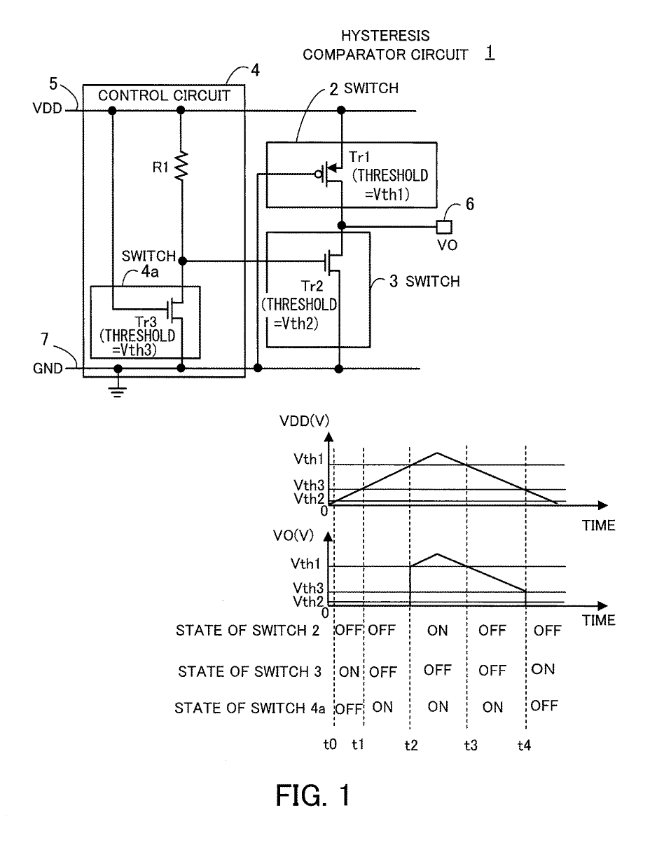

FIG. 1 depicts one example of a hysteresis comparator circuit according to a first embodiment.

A hysteresis comparator circuit 1 includes switches 2 and 3 and a control circuit 4.

The switch 2 is coupled between a power supply line 5 and an output terminal 6. When a power supply voltage VDD applied to the power supply line 5 is smaller than a first value (hereinafter referred to as “threshold Vth1”), the switch 2 is turned off, while when the power supply voltage VDD is equal to or larger than the threshold Vth1, the switch 2 is turned on.

As one example, the switch 2 is realized by a transistor Tr1 that is a p-channel MOSFET (Metal-Oxide Semiconductor Field Effect Transistor). The source terminal of the transistor Tr1 is coupled to the power supply line 5, the drain terminal is coupled to the output terminal 6, and the gate terminal is coupled to a reference power supply line 7 that is at a reference potential GND (for example, 0V). The transistor Tr1 is on when the absolute value of the gate-source voltage is equal to or greater than the threshold Vth1.

The switch 3 is coupled between the switch 2 and output terminal 6 and the reference power supply line 7.

As one example, the switch 3 is realized by a transistor Tr2 that is an n-channel MOSFET. The drain terminal of the transistor Tr2 is coupled to the drain terminal of the transistor Tr1 and the output terminal 6, the source terminal is coupled to the reference power supply line 7, and the gate terminal is coupled to the control circuit 4. Hereinafter, the gate-source voltage that turns the transistor Tr2 on is referred to as the “threshold Vth2”.

The control circuit 4 includes a switch 4a and a resistor R1. The switch 4a is coupled between the power supply line 5 and the reference power supply line 7. The switch 4a is off when the power supply voltage VDD is smaller than a second value (hereinafter referred to as the “threshold Vth3”) that is smaller than the threshold Vth1, and is on when the power supply voltage VDD is equal to or larger than the threshold Vth3.

As one example, the switch 4a is realized by a transistor Tr3 that is an n-channel MOSFET. The drain terminal of the transistor Tr3 is coupled to a control terminal of the switch 3 (i.e., the gate terminal of the transistor Tr2) and is coupled via the resistor R1 to the power supply line 5. The source terminal of the transistor Tr3 is coupled to the reference power supply line 7 and the gate terminal is coupled to the power supply line 5. The transistor Tr3 is turned on when the gate-source voltage reaches the threshold Vth3.

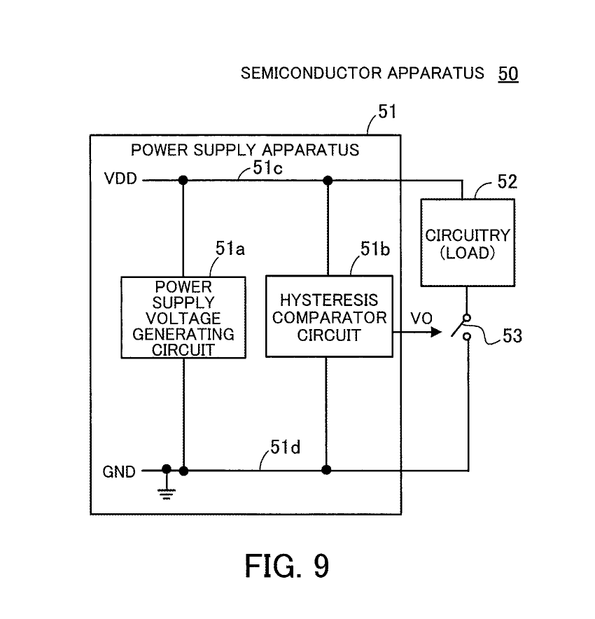

Note that in the hysteresis comparator circuit 1, the transistors Tr1 to Tr3 are selected based on factors such as the operating voltage of the load (see FIG. 9, described later) to which the power supply voltage VDD is applied and the size of the variations (i.e., noise) in the power supply voltage VDD and the like so as to produce a relationship where Vth1>Vth3>Vth2.

The resistor R1 is a pull-up resistor.

The control circuit 4 uses the switch 4a described above so as to turn the switch 3 on when the switch 4a is off, and to turn the switch 3 off when the switch 4a is on.

One example of the operation of the hysteresis comparator circuit 1 according to the first embodiment is described below.

In FIG. 1, the power supply voltage VDD and example states of the output value VO of the output terminal 6 and the switches 2, 3, and 4a are depicted. The vertical axis represents the power supply voltage VDD (in V) and the output value VO (in V), and the horizontal axis represents time.

In a state where the output value VO is 0V, when the power supply voltage VDD rises and reaches the threshold Vth2 (at timing t0), the switch 3 is turned on. Since the switches 2 and 4a are off at this time, the output value VO remains at 0V (the “L (Low) level”).

When the power supply voltage VDD rises further and reaches the threshold Vth3 (at timing t1), the switch 4a is turned on. As a result, the gate voltage of the transistor Tr2 becomes the L level and the switch 3 is turned off. Note that since the transistor Tr1 is off at this time, the output terminal 6 is placed in a floating state. For this reason, as described later, it is desirable to couple a latch circuit that holds the value of the output value VO at the timing t0 to t1 to the output terminal 6.

When the power supply voltage VDD rises further and reaches the threshold Vth1 (at timing t2), the switch 2 is turned on. Since the switch 3 is off at this time, the output value VO rises and reaches an H (High) level.

Although the switch 2 is turned off when the power supply voltage VDD falls and drops below the threshold Vth1 (at timing t3), since the switch 3 remains off, the output value VO does not become the L level.

When the power supply voltage VDD falls further and drops below the threshold Vth3 (at timing t4), the switch 4a is turned off. In a state where the power supply voltage VDD is not below the threshold Vth2, the switch 3 is turned on. As a result, the output value VO becomes the L level.

As described above, in the hysteresis comparator circuit 1 according to the present embodiment, the thresholds at which there are transitions in the potential of the output value VO between the L level and the H level differ between when the power supply voltage VDD is rising and when the power supply voltage VDD is falling. That is, a hysteresis operation is realized. The effects of this hysteresis operation are described below.

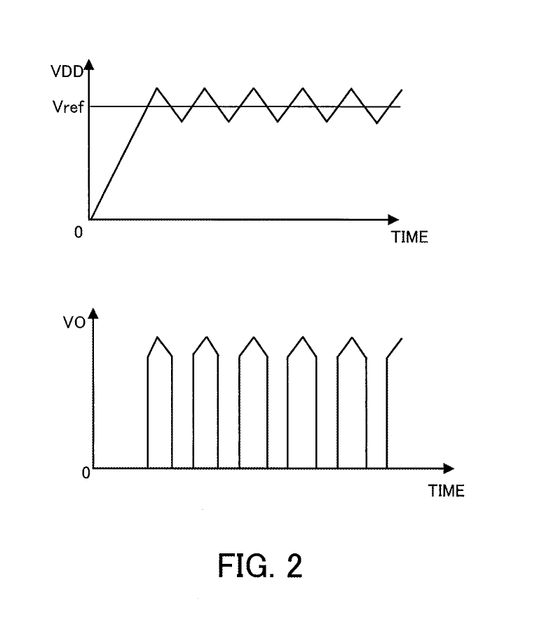

FIG. 2 depicts examples of output values based on comparison results for a single threshold and a power supply voltage.

The vertical axis represents the power supply voltage VDD and the output value VO, and the horizontal axis represents time.

The waveform of the power supply voltage VDD in FIG. 2 depicts a case where energy harvesting is used as a power supply and oscillates even when a threshold Vref is reached. In this case, the output value VO has frequent transitions (so-called “chattering”) between the L level and the H level. This results in circuits that operate based on the output value VO becoming unstable.

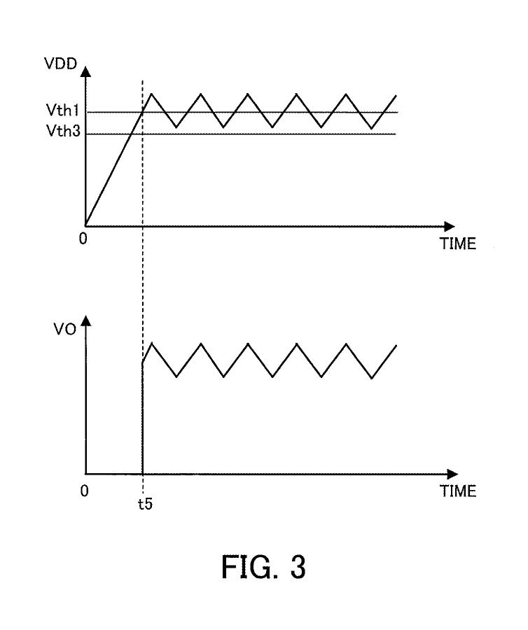

FIG. 3 depicts an example of the relationship between the power supply voltage and the output value of the hysteresis comparator circuit according to the present embodiment.

The vertical axis represents the power supply voltage VDD and the output value VO and the horizontal axis represents time.

For the waveform of the power supply voltage VDD depicted in FIG. 3, since the threshold Vth1 is reached at the timing t5, the output value VO becomes the H level. Although the power supply voltage VDD subsequently oscillates and frequently drops below the threshold Vth1, since the power supply voltage VDD does not drop below the threshold Vth3, the output value VO remains at the H level. This means that it is possible to prevent instability in circuits that operate based on the output value VO.

In addition, according to the hysteresis comparator circuit 1 described above, there is no path on which current continuously flows between the power supply line 5 and the reference power supply line 7 when the power supply voltage VDD is being generated. This means that as described below for example, it is possible to reduce power consumption compared to a hysteresis comparator circuit that sets a threshold by feeding back an output value to the input side.

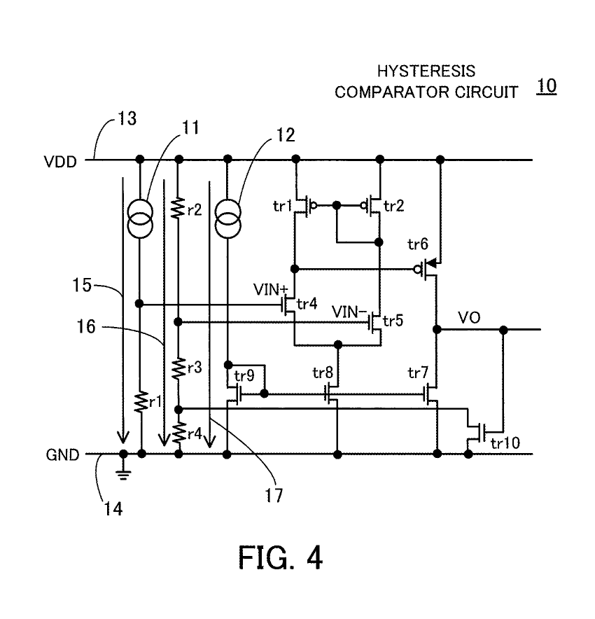

FIG. 4 depicts one example of a hysteresis comparator circuit that sets a threshold by feeding back an output value to the input side.

A hysteresis comparator circuit 10 includes transistors tr1 to tr10, resistors r1 to r4, and current supplies 11 and 12. The transistors tr1, tr2, and tr6 are p-channel MOSFETs and the transistors tr4, tr5, tr7, tr8, tr9, and tr10 are n-channel MOSFETs.

The source terminals of the transistors tr1 and tr2 are coupled to a power supply line 13 to which the power supply voltage VDD is supplied, and the gate terminals of the transistors tr1 and tr2 are coupled to the drain terminal of the transistor tr2. The drain terminal of the transistor tr1 is coupled to the drain terminal of the transistor tr4, and the drain terminal of the transistor tr2 is coupled to the drain terminal of the transistor tr5. The gate terminal of the transistor tr4 is coupled to a node between the resistor r1 and the current supply 11 which are coupled in series between the power supply line 13 and a reference power supply line 14. The gate terminal of the transistor tr5 is coupled to a node between the resistor r2 and the resistor r3 out of the resistors r2 to r4 which are coupled in series between the power supply line 13 and the reference power supply line 14. The source terminals of the transistors tr4 and tr5 are coupled to a drain terminal of the transistor tr8.

The source terminal of the transistor tr6 is coupled to the power supply line 13, and the drain terminal is coupled to the drain terminal of the transistor tr7. The gate terminals of the transistors tr7 to tr9 are coupled to the drain terminal of the transistor tr9. The source terminals of the transistors tr7 to tr9 are coupled to the reference power supply line 14. The drain terminal of the transistor tr9 is coupled to one end of the current supply 12 and the other end of the current supply 12 is coupled to the power supply line 13. The drain terminal of the transistor tr10 is coupled to a node between the resistor r3 and the resistor r4 and the source terminal is coupled to the reference power supply line 14. The gate terminal of the transistor tr10 is coupled to a node between the drain terminal of the transistor tr6 and the drain terminal of the transistor tr7.

In this hysteresis comparator circuit 10, an input voltage VIN+ based on the power supply voltage VDD is inputted into the gate terminal of the transistor tr4. Based on the output value VO that is the voltage at the drain terminal of the transistor tr6, the transistor tr10 is turned on or off, and an input voltage VIN− that is a threshold in keeping with the on or off state is inputted into the gate terminal of the transistor try.

In the hysteresis comparator circuit 10 described above, when the power supply voltage VDD is generated, there are three paths 15, 16 and 17 on which a current continuously flows between the power supply line and the reference power supply line 14. This means that the power consumption is large and it is difficult to use such hysteresis comparator circuit 10 in circuits that operate on low power, such as those that use energy harvesting.

On the other hand, with the hysteresis comparator circuit 1 in FIG. 1, the switch 4a that is turned on by a power supply voltage VDD that is smaller than the switch 2 at the output stage is provided between the power supply line 5 and the reference power supply line 7, and by having the switch 4a control the switch 3, a hysteresis operation is realized. Since the switch 4a is not always on, with the hysteresis comparator circuit 1 depicted in FIG. 1, there is no path on which a current continuously flows between the power supply line 5 and the reference power supply line 7. Note that although the switch 4a is on while the power supply voltage VDD is equal to or above the threshold Vth3 (i.e., between the timings t1 to t4), the only path on which a current flows is the path that includes the switch 4a. This means that compared to the hysteresis comparator circuit 10 depicted in FIG. 4, it is possible to reduce power consumption and easy to apply the hysteresis comparator circuit 1 to circuits that operate on low power, such as when energy harvesting is used.

Since the circuit configuration of the hysteresis comparator circuit 1 depicted in FIG. 1 is simple, it is also possible to reduce the circuit area.

### Second Embodiment

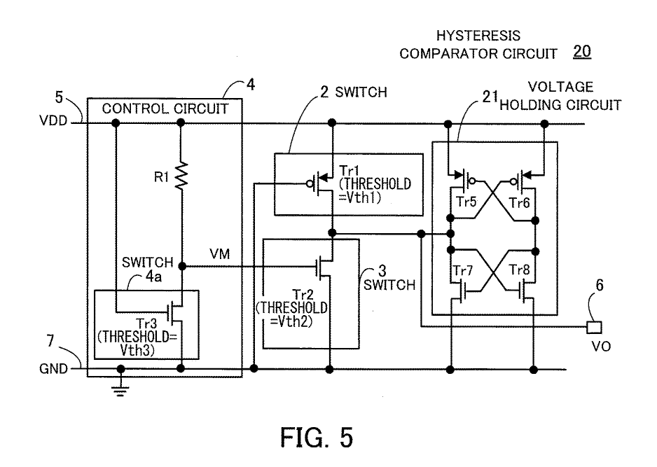

FIG. 5 depicts an example of a hysteresis comparator circuit according to a second embodiment.

In FIG. 5, elements that are the same as the hysteresis comparator circuit 1 depicted in FIG. 1 have been assigned the same reference numerals.

A hysteresis comparator circuit 20 according to the second embodiment includes a voltage holding circuit 21. The voltage holding circuit 21 is coupled to the output terminal 6 and holds the output value VO (voltage value) of the output terminal 6 before the switches 2 and 3 both change to an off state (that is, before the output terminal 6 is placed in a floating state).

The voltage holding circuit 21 includes transistors Tr5 to Tr8. The transistors Tr5 and Tr6 are p-channel MOSFETs and the transistors Tr7 and Tr8 are n-channel MOSFETs.

The source terminals of the transistors Tr5 and Tr6 are coupled to the power supply line 5. The gate terminal of the transistor Tr5 is coupled to the drain terminal of the transistor Tr6 and the gate terminal of the transistor Tr6 is coupled to the drain terminal of the transistor Tr5. The drain terminal of the transistor Tr5 is coupled to the drain terminal of the transistor Tr7 and the drain terminal of the transistor Tr6 is coupled to the drain terminal of the transistor Tr8. The gate terminal of the transistor Tr7 is coupled to the drain terminal of the transistor Tr8 and the gate terminal of the transistor Tr8 is coupled to the drain terminal of the transistor Tr7. The source terminals of the transistors Tr7 and Tr8 are coupled to the reference power supply line 7. The drain terminals of the transistors Tr5 and Tr7 are coupled to the drain terminals of the transistors Tr1 and Tr2 and the output terminal 6.

In the voltage holding circuit 21, when the output value VO becomes the L level, the transistors Tr6 and Tr7 are turned on and the voltage value of the output terminal 6 (that is, the “output value VO”) is fixed at the L level.

When the output value VO becomes the H level, the transistors Tr5 and Tr8 are turned on and the voltage value of the output terminal 6 (that is, the “output value VO”) is fixed at the H level.

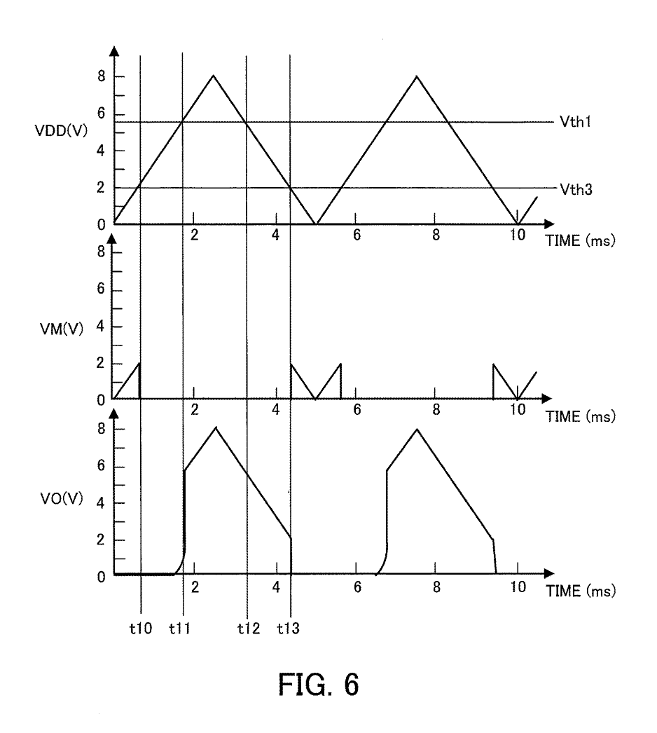

FIG. 6 depicts one example of operation simulation results for the hysteresis comparator circuit according to the second embodiment.

The vertical axis represents the power supply voltage VDD (in V), the gate voltage VM (in V) of the transistor Tr2, and the output value VO (in V), and the horizontal axis represents time (in ms).

When the power supply voltage VDD starts to rise, the gate voltage VM also rises. Although not depicted in the drawing, when the power supply voltage VDD reaches the threshold Vth2, the switch 3 is turned on and the output value VO becomes 0V. Since the switch 4a is turned on when the power supply voltage VDD reaches the threshold Vth3 (at timing t10), the gate voltage VM becomes 0V. At this time, the switches 2 and 3 are turned off. However, since the voltage value of the output terminal 6 is fixed at the L level by the voltage holding circuit 21, the output terminal 6 is not placed in a floating state.

When the power supply voltage VDD rises further and reaches the threshold Vth1 (at timing t11), the switch 2 is turned on, and the output value VO rises to the H level.

When the power supply voltage VDD falls and drops below the threshold Vth1 (at timing t12), the switch 2 is turned off. Although the switch 3 also is turned off at this time, as depicted in FIG. 6, due to the voltage holding circuit 21, the output value VO becomes a value (the H level value) in keeping with the power supply voltage VDD and is not placed in a floating state.

Since the switch 4a is turned off when the power supply voltage VDD falls further and drops below the threshold Vth3 (at timing t13), the gate voltage VM becomes the value of the power supply voltage VDD and the switch 3 is turned on. By doing so, the output value VO becomes the L level. The gate voltage VM also falls together with the fall in the power supply voltage VDD. Although not depicted in the drawing, when the gate voltage VM drops below the threshold Vth2, the switch 3 is turned off.

The operation described above is thereafter repeated.

According to the hysteresis comparator circuit according to the second embodiment, since the output terminal 6 is prevented from being placed in a floating state by the voltage holding circuit 21, it is possible to prevent the output value VO from becoming unstable and the operation of circuits that are coupled to the output terminal 6 from becoming unstable.

### Third Embodiment

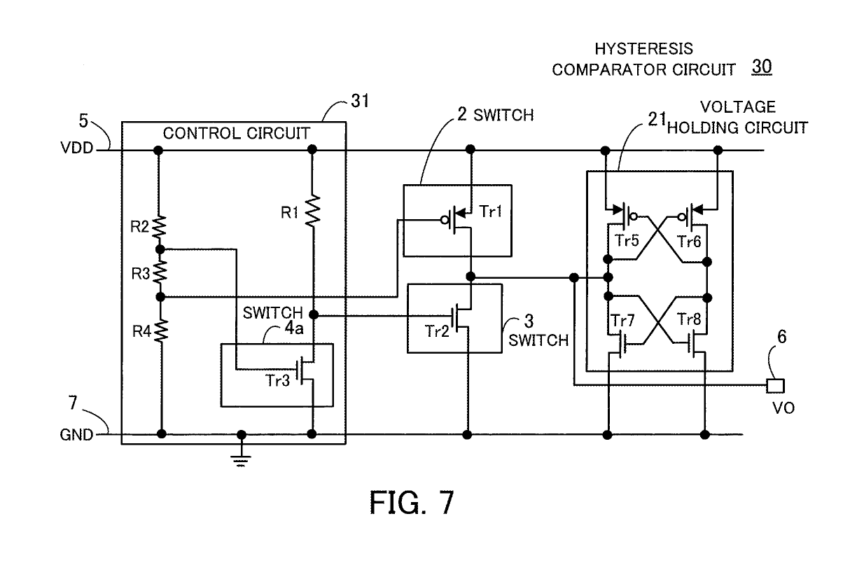

FIG. 7 depicts an example of a hysteresis comparator circuit according to a third embodiment.

In FIG. 7, elements that are the same as the hysteresis comparator circuit 20 depicted in FIG. 5 have been assigned the same reference numerals.

The hysteresis comparator circuit 30 according to the third embodiment has a control circuit (the control circuit 31) with a different configuration to the hysteresis comparator circuit 20 according to the second embodiment. In addition to the switch 4a and the resistor R1, the control circuit 31 of the hysteresis comparator circuit 30 includes resistors R2, R3, and R4 coupled in series between the power supply line 5 and the reference power supply line 7. The gate terminal of the transistor Tr1 is coupled to a node between the resistor R3 and the resistor R4 and the gate terminal of the transistor Tr3 is coupled to a node between the resistor R2 and the resistor R3.

With the hysteresis comparator circuit 30, the switches 2 and 4a are controlled by the power supply voltage VDD which is divided using the resistors R2 to R4.

With the hysteresis comparator circuits 1 and 20 according to the first and second embodiments, the thresholds Vth1, Vth2, and Vth3 of the switches 2, 3, and 4a are set at the gate-source voltages (absolute values) at which the transistors Tr1, Tr2, and Tr3 are turned on, with such voltages being such that Vth1>Vth3>Vth2. However, the hysteresis comparator circuit 30 according to the third embodiment is not limited to this relationship.

However, a gate voltage obtained by dividing the power supply voltage VDD using the resistors R2 to R4 is applied to the gate terminal of the transistor Tr1 so that when the power supply voltage VDD is the threshold Vth1 for example, the transistor Tr1 is turned on.

Also, a gate voltage obtained by dividing the power supply voltage VDD using the resistors R2 to R4 is applied to the gate terminal of the transistor Tr3 so that when the power supply voltage VDD is the threshold Vth3 for example, the transistor Tr3 is turned on.

This means that when the values of the resistors R2 to R4 described above are appropriately adjusted, the gate-source voltages that respectively turn on the transistors Tr1 to Tr3 do not need to satisfy the relationship for the thresholds Vth1 to Vth3 given above.

As one example, when the absolute values of the gate-source voltages that turn on the transistors Tr1 to Tr3 are set at the same value |Vth|, to produce a hysteresis characteristic, the values of the resistors R2 to R4 are set so as to satisfy R4/(R2+R3)>R2/(R3+R4). As one example, the value of the resistor R4 is set at 20MΩ and the values of the resistors R2 and R3 are set at 10MΩ.

Here, when VDD>{1+R4/(R2+R3)}·|Vth|, the output value VO=VDD (H level), while when VDD<{1+R2/(R3+R4)}·|Vth|, the output value VO=0V (L level).

According to the hysteresis comparator circuit 30 described above, the same hysteresis characteristic can be realized even if the gate-source voltages that turn the transistors Tr1 to Tr3 on do not satisfy the relationship for the thresholds Vth1 to Vth3 given above. Also, in order to perform a hysteresis operation even when there are fluctuations in the gate-source voltages that turn on the transistors Tr1, Tr2, and Tr3 due to changes in environmental temperature, it is possible to set the values of the resistors R2 to R4 so as to achieve a suitable margin between the thresholds Vth1 and Vth3.

Note that in the hysteresis comparator circuit 30 according to the third embodiment, although paths can be formed between the power supply line 5 and the reference power supply line 7 by the resistors R2 to R4, compared to the hysteresis comparator circuit 10 depicted in FIG. 4, there are few paths on which current continuously flows between the power supply line 5 and the reference power supply line 7. This means that it is possible to achieve substantially the same effect as the hysteresis comparator circuit 20 according to the second embodiment.

Note that the number of the resistors R2 to R4 is not limited to three, and four or more resistors may be used.

### Fourth Embodiment

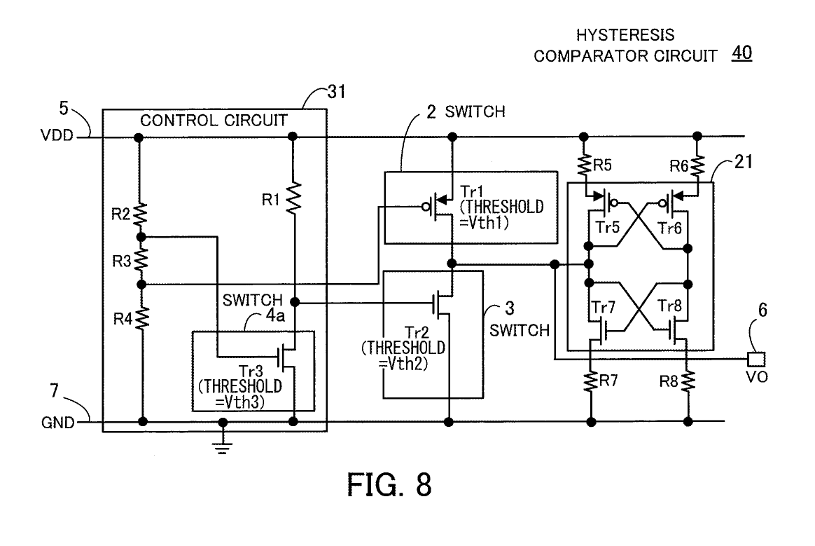

FIG. 8 depicts an example of a hysteresis comparator circuit according to a fourth embodiment.

In FIG. 8, elements that are the same as the hysteresis comparator circuit 30 depicted in FIG. 7 have been assigned the same reference numerals.

In a hysteresis comparator circuit 40 according to the fourth embodiment, a plurality of resistors R5, R6, R7, and R8 are coupled between the voltage holding circuit 21 and the power supply line 5 and reference power supply line 7.

As depicted in FIG. 8, the resistors R5 and R6 are coupled between the power supply line 5 and the source terminals of the transistors Try and Tr6 of the voltage holding circuit 21. In addition, the resistors R7 and R8 are coupled between the reference power supply line 7 and the source terminals of the transistors Tr7 and Tr8. By providing the resistors R5 to R8, it is possible to reduce the increase in power consumption due to through currents inside the voltage holding circuit 21 when the output value VO inverts. Note that a configuration may be used where the resistors R5 to R8 are coupled either between the voltage holding circuit 21 and the power supply line 5 or between the voltage holding circuit 21 and the reference power supply line 7.

Note that in the hysteresis comparator circuit 20 depicted in FIG. 5 also, it is possible to couple the resistors R5 to R8 as depicted in FIG. 8 between the voltage holding circuit 21 and the power supply line 5 or the reference power supply line 7.

As one example, the hysteresis comparator circuits 1, 20, 30, and 40 according to the embodiments described above are used in a power supply apparatus such as that described below.

FIG. 9 depicts one example of a power supply apparatus and a semiconductor apparatus including such power supply apparatus.

A semiconductor apparatus 50 includes a power supply apparatus 51, circuitry (the load) 52, and a switch 53.

The power supply apparatus 51 includes a power supply voltage generating circuit 51a and a hysteresis comparator circuit 51b that are coupled between a power supply line 51c and a reference power supply line 51d.

The power supply voltage generating circuit 51a generates the power supply voltage VDD. As one example, the power supply voltage generating circuit 51a generates the power supply voltage VDD by energy harvesting.

As one example, the hysteresis comparator circuit 51b is any of the hysteresis comparator circuits 1, 20, 30, and 40 described earlier and outputs the output value VO based on the power supply voltage VDD and the thresholds Vth1, Vth2, and Vth3.

The hysteresis comparator circuit 51b controls the switch 53 using the output value VO to control the supplying of power to the circuitry 52. As one example, when the output value VO is at the H level, the switch 53 is turned on and power is supplied to the circuitry 52, while when the output value VO is at the L level, the switch 53 is turned off and supplying of power to the circuitry 52 is shut off.

By using one of the hysteresis comparator circuits 1, 20, 30, and 40 described earlier as the hysteresis comparator circuit 51b of the power supply apparatus 51, it is possible to reduce the power consumption of the power supply apparatus 51 and the semiconductor apparatus 50 that includes the power supply apparatus 51.

According to the hysteresis comparator circuits and the power supply apparatus according to the present embodiments, it is possible to reduce power consumption.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A hysteresis comparator circuit comprising:
a first switch coupled between a power supply line and an output terminal, the first switch being configured to be turned off when a power supply voltage applied to the power supply line is smaller than a first value and be turned on when the power supply voltage is equal to or larger than the first value;
a second switch coupled between the output terminal and a reference power supply line that is at a reference potential; and
a control circuit that includes a third switch coupled between the power supply line and the reference power supply line, the third switch being configured to be turned off when the power supply voltage is smaller than a second value that is smaller than the first value, and be turned on when the power supply voltage is equal to or larger than the second value, wherein
the control circuit is configured to
turn the second switch on when the third switch is off, and
turn the second switch off when the third switch is on.

2. The hysteresis comparator circuit according to claim 1, further comprising a voltage holding circuit that holds a voltage value of the output terminal.

3. The hysteresis comparator circuit according to claim 1,
wherein the first switch is a p-channel field effect transistor,
the second switch is a first n-channel field effect transistor,
the third switch is a second n-channel field effect transistor whose drain terminal is coupled to a gate terminal of the first n-channel field effect transistor,
an absolute value of a first gate-source voltage at which the p-channel field effect transistor is turned on is the first value,
an absolute value of a second gate-source voltage at which the second n-channel field effect transistor is turned on is the second value, and
a third gate-source voltage at which the first n-channel field effect transistor is turned on is smaller than the second gate-source voltage.

4. The hysteresis comparator circuit according to claim 1,
wherein the first switch is a p-channel field effect transistor,
the second switch is a first n-channel field effect transistor,
the third switch is a second n-channel field effect transistor whose drain terminal is coupled to a gate terminal of the first n-channel field effect transistor,
the control circuit further includes a plurality of resistors coupled in series between the power supply line and the reference power supply line,
a first gate voltage that is produced by dividing the power supply voltage using the plurality of resistors is applied to the p-channel field effect transistor so as to turn on the p-channel field effect transistor when the power supply voltage is the first value, and
a second gate voltage that is produced by dividing the power supply voltage using the plurality of resistors is applied to the second n-channel field effect transistor so as to turn on the second n-channel field effect transistor when the power supply voltage is the second value.

5. The hysteresis comparator circuit according to claim 2, further comprising a plurality of resistors coupled between the voltage holding circuit and one of the power supply line and the reference power supply line.

6. A power supply apparatus comprising:
a power supply voltage generating unit that generates a power supply voltage; and
a hysteresis comparator circuit including:
a first switch coupled between a power supply line and an output terminal, the first switch being configured to be turned off when the power supply voltage applied to the power supply line is smaller than a first value and be turned on when the power supply voltage is equal to or larger than the first value;
a second switch coupled between the output terminal and a reference power supply line that is at a reference potential; and
a control circuit that includes a third switch coupled between the power supply line and the reference power supply line, the third switch being configured to be turned off when the power supply voltage is smaller than a second value that is smaller than the first value and be turned on when the power supply voltage is equal to or larger than the second value, wherein
the control circuit is configured to turn the second switch on when the third switch is off, and turn the second switch off when the third switch is on.
